(19) United States
(12) Patent Application Publication
(10) Pub. No.: US 2015/0315405 A1
(43) Pub. Date: Nov. 5, 2015

(54) Sealant Composition and Display Apparatus

(71) Applicants: BOE TECHNOLOGY GROUP CO., LTD., Beijing (CN); BEIJING BOE OPTOELECTRONICS TECHNOLOGY CO., LTD, Beijing (CN)

(72) Inventors: Jian LI, Beijing (CN); Wei ZHANG, Beijing (CN); Hongpeng LI, Beijing (CN); Sunghun SONG, Beijing (CN)

(21) Appl. No.: 14/498,088

(22) Filed: Sep. 26, 2014

(30) Foreign Application Priority Data
Apr. 30, 2014 (CN) 201410183393.4

(51) Int. Cl. C09D 133/08; B32B 7/12; G02F 1/1339

(52) U.S. Cl. CPC C09D 133/08; G02F 1/1339; B32B 7/12; B32B 2457/202

(57) ABSTRACT

The invention discloses a sealant composition used for improving residual image, which comprises a heat-curable and/or UV-curable primary sealant and a both UV-curable and moisture-curable secondary sealant. In the sealant composition of the present invention, a “multi-curable” sealant system is built by introducing a novel dual-curable resin as the secondary sealant into the conventional sealant, wherein the primary sealant can impart sufficient strength to the sealant composition through heat-curing and/or UV-curing, and the secondary sealant can adsorb the water vapor between the glass substrates through UV-curing and moisture-curing. The primary sealant and the secondary sealant are used together for bonding glass substrates, which can avoid the insufficient adhesion of the conventional sealant caused by solvent molecules (e.g. water vapor etc.) during the encapsulation of glass substrates, and ensure high adhesion strength and strong collapse resistance of the sealant.

### FIELD OF THE INVENTION

The present invention relates to the liquid crystal display field, particularly relates to a sealant composition and a display apparatus.

### BACKGROUND OF THE INVENTION

Nowadays, narrow bezel and high-quality image have been a common purpose sought by the manufactures and the demanders during the development of display apparatus. However, the problem of residual image in the image quality tends to be existed in the known display structure. There is evidence that the presence of foreign molecules inside the liquid crystal plane results in the formation of residual image remained at high temperature. When a conventional alignment layer polyimide (Pl) and sealant are treated by overlap coating method (i.e., coating polyimide and sealant in an overlap way), the water molecules or other cleaning solvent adsorbed, in the cleaning process, on the surface of the strongly polar alignment layer polyimide after rubbing are difficult to be removed completely simply using the current drying methods such as air knife and infrared drying (see FIG. 1), and then the residual water molecules or other cleaning solvent lead to insufficient adhesiveness between the alignment layer polyimide and the sealant, thereby causing occurrence of insufficient adhesion in the evaluation of reliability (i.e., substandard peel off) or residual image at high-temperature. Even if the alignment layer polyimide and the sealant are not coated in an overlap way, a certain amount of water molecules or other solvent molecules are also adsorbed in the area coated with polyimide. Meanwhile these water molecules or other solvent molecules diffuse with time on the alignment layer after rubbing along the direction of rubbing. When the diffused water molecules come into the sealant area, the phenomenon of insufficient adhesion between the alignment layer polyimide and the sealant occurs. Generally, a conventional sealant component is UV-curable or heat-curable, or both, and it can not avoid the effect caused by moisture, therefore the adhesiveness property of sealant can not be achieved effectively, which tends to result in the problem of substandard reliability in the display apparatus applying a narrow bezel design.

Consequently, it is necessary to provide a desirable sealant composition to overcome the above technical defect.

### SUMMARY OF THE INVENTION

The object of the present invention is to achieve significant improvement in the properties of sealant composition, by introducing a secondary sealant component which is both UV-curable and moisture-curable into the conventional heat-curable and/or UV-curable sealant component so as to constitute a “multi-curable” sealant system.

In order to achieve the above object, the present invention provides a sealant composition comprising a primary sealant that is heat-curable and/or UV-curable, and a secondary sealant that is both UV-curable and moisture-curable.

In the sealant composition of the present invention, the secondary sealant comprises a dual-curable resin which is a silicone resin including an UV-curable group

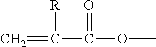

and a Si-containing moisture-curable group, wherein R in the UV-curable group is H or C1˜C20 alkyl, and at least one —OCH₃ group is linked to the silicone atom in the Si-containing moisture-curable group.

Further, the dual-curable resin of the present invention has a general structure represented by formula I:

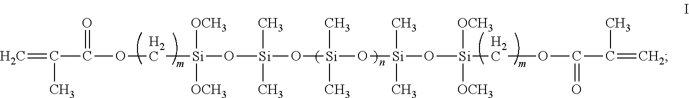

wherein, m≧2, n≧0; preferably, m is 2˜0, n is 0˜20; and more preferably, m is 2˜6, n is 3˜15.

In the most preferable embodiment, the dual-curable resin of the present invention is the compound represented by formula II:

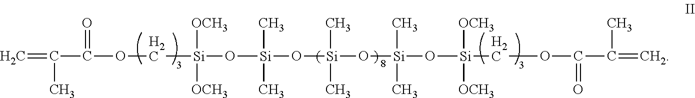

The secondary sealant further comprises a bifunctional initiator capable of initiating UV-curing and moisture-curing of the dual-curable resin in the secondary sealant.

The bifunctional initiator of the present invention is obtained from a modification reaction between hydrogen-containing silicone oil and 2-hydroxy-2-methylpropiophenone.

The synthetic route of the above bifunctional initiator is as follows:

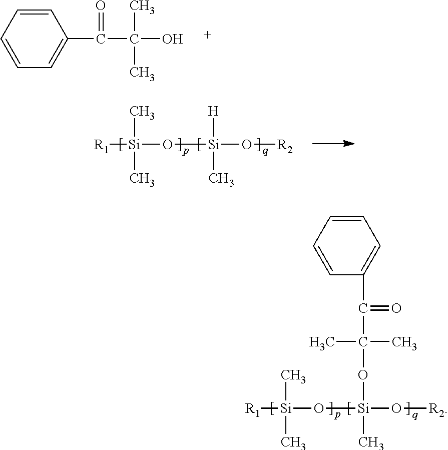

That is, the bifunctional initiator is obtained from a modification reaction between hydrogen-containing silicone oil and 2-hydroxy-2-methylpropiophenone in the present of a basic catalyst;

wherein R₁ and R₂, which may be identical or different, are each individually C1˜C20 alkyl or phenyl, and the alkyl or phenyl may be optionally substituted by phenyl which is unsubstituted or substituted by one or more alkyl groups. For example, the alkyl may be methyl, ethyl, propyl, butyl, etc. Said p≧2, q≧2. Preferably, p is 2˜20, q is 2˜20; more preferably, p is 3˜15, q is 3˜15.

More particularly, the composition of the present invention comprises, in terms of weight parts, 10˜30 parts of epoxy resin, 20˜45 parts of acrylic resin, 1˜3 parts of UV photoinitiator, 1˜3 parts of heat curing agent, 5˜15 parts of inorganic filler and 0˜5 parts of organic filler, 1˜10 parts of dual-curable resin, and 1˜1.5 parts of bifunctional initiator.

Preferably, the epoxy resin is selected from E51 or E44; the acrylic resin is one or more selected from t-butyl acrylate resin, methyl acrylate resin or triphenylmethyl acrylate resin; the UV photoinitiator is alkyl acetone photoinitiator the heat curing agent is selected from amine heat curing agent; the inorganic filler is selected from silica, titania or alumina; and the organic filler is selected from cross-linked acrylic monodisperse particles.

More preferably, the alkyl acetone photoinitiator is UV5184 (1-hydroxycyclohexyl phenyl ketone) and/or UV5173 (2-hydroxy-2-methylpropiophenone), the organic filler is MX-1500H, and the amine heat curing agent is a modified aromatic amine heat curing agent.

In the most preferable embodiment of the present invention, the sealant composition comprises the following raw materials (by weight parts): epoxy resin E51 or E44 20˜25 parts, acrylic resin of t-butyl acrylate resin 30˜40 parts, UV photoinitiator UV5184 1˜3 parts, modified aromatic amine heat curing agent R-3200 1˜3 parts, inorganic filler of silica 10˜12 parts, organic filler of cross-linked acrylic monodisperse particles MX-1500H 2˜5 parts, dual-curable resin 4˜8 parts, and bifunctional initiator 1˜1.5 parts; wherein, the dual-curable resin has a structure of:

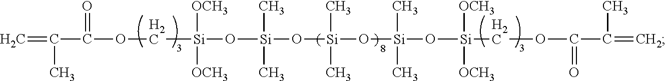

and the bifunctional initiator has a structure of:

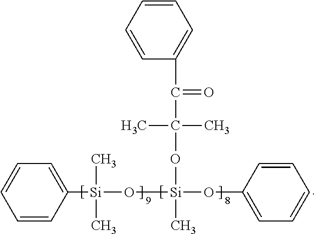 [SMILES: CC(C)(O[Si](C)(Oc1ccccc1)O[Si](C)(C)c1ccccc1)C(=O)c1ccccc1]

The present invention also claims a method for preparing the above sealant composition, specifically comprising: uniformly mixing the primary sealant with the UV-curable and moisture-curable secondary sealant, thus obtaining the sealant composition.

Moreover, the present invention further claims a display apparatus which comprises a first substrate and a second substrate that are disposed oppositely, and the first substrate and the second substrate are bonded by the sealant composition of the present invention.

In the present invention, a “multi-curable” sealant system is built by introducing a novel dual-curable resin and a corresponding bifunctional initiator as the secondary sealant into the conventional sealant. The sealant system has the primary sealant with heat-curable and/or UV-curable properties so as to impart sufficient strength to the cured sealant, and the secondary sealant with UV-curable and moisture-curable properties through corresponding curable groups. The primary sealant and the secondary sealant are used together for bonding glass substrates, which can avoid the insufficient adhesion of the conventional sealant caused by solvent molecules (e.g. water vapor etc.) during the encapsulation of glass substrates, and ensure high adhesion strength and strong collapse resistance of the sealant.

### DESCRIPTION OF THE FIGURES

FIG. 1 is a schematic view showing the relationship between water adsorption capacity of the alignment layer polyimide and humidity.

### DETAILED DESCRIPTION OF CERTAIN EMBODIMENTS

In the present invention, the application performance of a sealant composition has been improved by introducing a secondary sealant component which is both UV-curable and moisture-curable into the conventional heat-curable and/or UV-curable sealant composition so as to constitute a “multi-curable” sealant system.

The secondary sealant of the present invention comprises a dual-curable resin which is a silicone resin including an UV-curable group

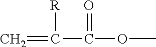

and a Si-containing moisture-curable group, wherein R in the UV-curable group is H or C1˜C20 alkyl, and at least one —OCH₃ group is linked to the silicone atom in the Si-containing moisture-curable group.

That is to say, the UV-curable group

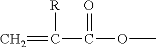

and the Si-containing moisture-curable group must be contained in the structure of the dual-curable resin of the present invention simultaneously, wherein R in the UV-curable group is H or C1˜C20 alkyl, and at least one —OCH₃ group is linked to the silicone atom in the Si-containing moisture-curable group. Typically, the UV-curable group

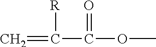

is at both ends of the dual-curable resin, but the present invention is not limited to these particular substitution sites. In the Si-containing moisture-curable group, at least one —OCH₃ group is linked to the silicone atom, and preferably two —OCH₃ groups are linked to a silicone atom in order to achieve a better cross-linking effect. The specific positions or the linking relation of the UV-curable group and the Si-containing moisture-curable group in the dual-curable resin are not particularly limited in the present invention. A person skilled in the art may understand that, a silicone resin can be used as the dual-curable resin in the secondary sealant of the present invention as long as it contains the above two groups, and it will realize UV-curing and moisture-curing in a suitable condition.

Preferably, the above dual-curable resin has a general structure represented by formula I:

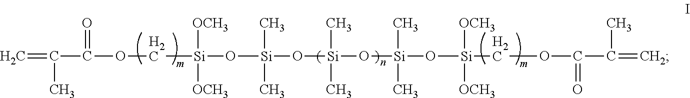

wherein, m≧2, n≧0; preferably, m is 2˜30, n is 0˜20; and more preferably, m is 2˜6, n is 3˜15.

More preferably, the dual-curable resin is the compound represented by formula II to obtain a better effect when application:

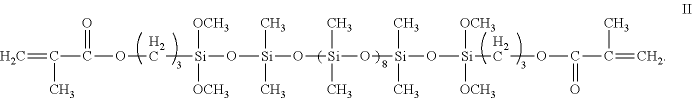

The preparation method of the dual-curable resin of the present invention is known in prior art. For example, the dual-curable resin may be obtained from a dealcoholization reaction at 6° C. in a nitrogen atmosphere using hydroxyl-terminated silicone oil (107) (manufactured by Jinan Hailan Chemical industry Co., Ltd.) and methacryloxy propyl trimethoxy silane (KH570) (manufactured by Sinopharm Chemical Reagent Co., Ltd.) as raw materials, and dibutyltin dilaurate as catalyst with an amount of 300 ppm. Moreover, for a person skilled in the art, the dual-curable resin may be prepared by other methods, which are not particularly limited in the present invention.

The secondary sealant further comprises a bifunctional initiator capable of initiating UV-curing and moisture-curing of the secondary sealant. The bifunctional initiator of the present invention is obtained from a modification reaction between hydrogen-containing silicone oil and 2-hydroxy-2-methylpropiophenone.

The synthetic route of the above bifunctional initiator is as follows:

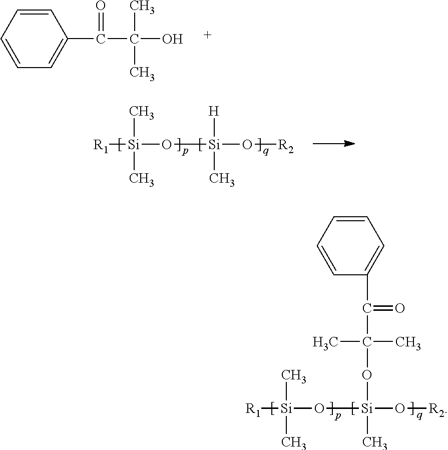

The bifunctional initiator is obtained from a modification reaction between hydrogen-containing silicone oil and 2-hydroxy-2-methylpropiophenone in the present of a basic catalyst; wherein R₁ and R₂, which may be identical or different, are each individually C1˜C20 alkyl or phenyl, and the alkyl or phenyl may be substituted by phenyl which is unsubstituted or substituted by one or more alkyl groups. For example, the alkyl may be methyl, ethyl, propyl, butyl, etc. Said p≧2, q≧2. Preferably, p is 2˜20, q is 2˜20; more preferably, p is 3˜15, q is 3˜15.

The modification reaction is conducted at 6° C. in a nitrogen atmosphere. The hydrogen content in the hydrogen-containing silicone oil is in a range of 0.5˜2.0 mol/g, preferably in a range of 0.65˜0.8 mol/g. The basic catalyst is an inorganic catalyst or an organic basic catalyst. For example, it may be selected from potassium hydroxide, sodium carbonate, potassium carbonate, or diethanolamine, etc. The bifunctional initiator may be prepared by other methods, which are not particularly limited in the present invention.

Preferably, the bifunctional initiator has a structure as follows

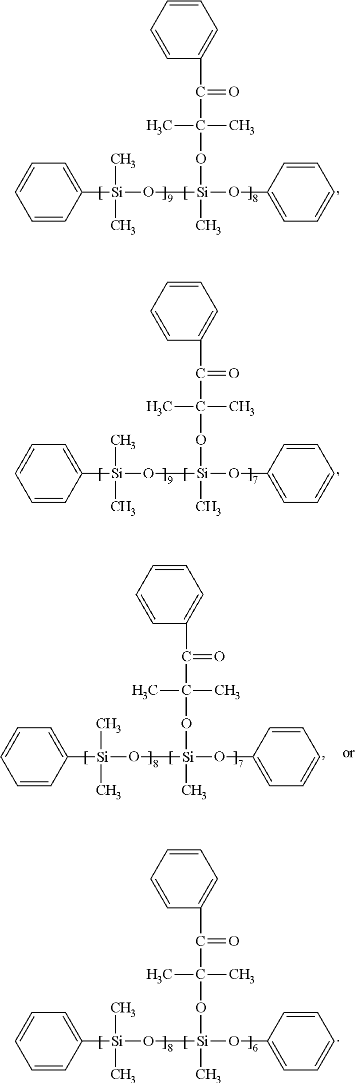

The dual-curable resin of the present invention forms a cross-linked network by Si—O—Si bonds through UV curing and moisture-curing. An illustrative, non-limiting UV-curing mechanism is shown as below, wherein the dual-curable resin and the bifunctional initiator of the present invention may be derived from the compounds with specific substituent groups being replaced:

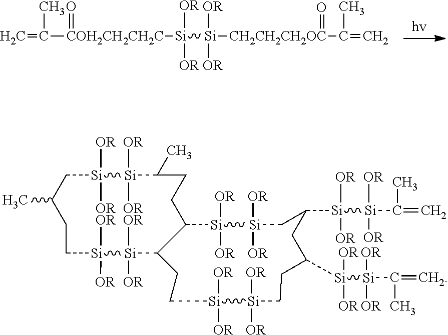

An illustrative, non-limiting moisture-curing mechanism included the dual-curing mechanism is shown as below

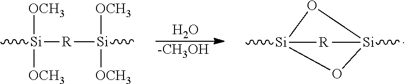

The dual-curable resin compound of the present invention has the advantages of realizing UV-curing and moisture-curing simultaneously, therefore as a result of water contained in the glass substrate with a little amount as well as the initiation effect of the bifunctional initiator, the Si-containing moisture-curable group in the dual-curable resin undergoes moisture-curing reaction, thereby causing strong adhesion with the surface of the glass substrate. On the other hand, the UV-curable group in the dual-curable resin can also be UV-cured in the initiation effect of the above bifunctional initiator, thereby forming a cross-linked structure.

Furthermore, the above secondary sealant component may also comprise other materials having UV-curing and moisture-curing effects, which are not particularly limited in the present invention.

The primary sealant based on heat-curing and/or UV-curing mechanism can be used in the present invention. When the curing form of the primary sealant is simply UV-curing, the UV-curing in the primary sealant and the secondary sealant as well as the moisture-curing in the secondary sealant proceeds simultaneously to form a cross-linked system.

When the curing form of the primary sealant includes heat-curing (i.e., the curing mechanism includes only heat-curing or both UV-curing and heat-curing), the UV-curing and the moisture-curing of the sealant composition proceed firstly, wherein said UV-curing comprises each UV-curing process of the primary sealant and the secondary sealant if the primary sealant is UV-curable. During said UV-curing process, main chains which have reactive pendant groups with the heat-curable sealant component are preformed. Then the main chains generated during said UV-curing process further take place a cross-linked curing process during the followed heat-curing process, so as to enhance the adhesion with the alignment layer or the glass substrate. Preferably, the primary sealant of the present invention is UV-curable and heat-curable, in order to be cross-linked with the secondary sealant more desirably.

The present invention further provides a more specific technical solution, in which the composition is defined to comprise (by weight parts): 10˜30 parts of epoxy resin, 20˜45 parts of acrylic resin, 1˜3 parts of UV photoinitiator, 1˜3 parts of heat curing agent, 5˜15 parts of inorganic filler and 0˜5 parts of organic filler, 1˜10 parts of dual-curable resin, and 1˜1.5 parts of bifunctional initiator.

Wherein, the epoxy resin is selected from E51 or E44; the acrylic resin is one or more selected from t-butyl acrylate resin, methyl acrylate resin or triphenylmethyl acrylate resin; the UV photoinitiator is alkyl acetone photoinitiator, the heat curing agent is selected from amine heat curing agent; the inorganic filler is selected from silica, titania or alumina; and the organic filler is selected from cross-linked acrylic monodisperse particles.

Preferably, the alkyl acetone photoinitiator is UV5184 and/or UV5173, and the organic filler is MX-1500H.

The amine heat curing agent refers to modified aromatic amine heat curing agent, such as R-3200, etc.

Further, as a preferable embodiment, the composition of the present invention comprises the following raw materials (by weight parts):

epoxy resin E51 or E44 20˜25 parts, acrylic resin of t-butyl acrylate resin 30˜40 parts, UV photoinitiator UV5184 1˜3 parts, modified aromatic amine heat curing agent R-3200 1˜3 parts, inorganic filler of silica 10˜12 parts, organic filler of cross-linked acrylic monodisperse particles MX-1500H 2˜5 parts, dual-curable resin 4˜8 parts, and bifunctional initiator 1˜1.5 parts; wherein, the dual-curable resin has a structure of:

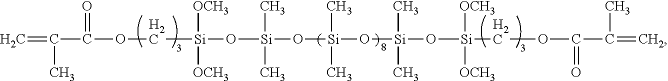

and the bifunctional initiator has a structure of

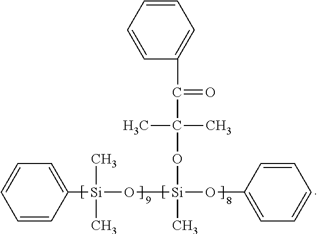 [SMILES: CC(C)(O[Si](C)(Oc1ccccc1)O[Si](C)(C)c1ccccc1)C(=O)c1ccccc1]

Particularly, the preparation method of the above sealant composition comprises: uniformly mixing the heat-curable and/or UV-curable primary sealant with the UV-curable and moisture-curable secondary sealant component before use, thus obtaining the sealant composition. This preparation method facilitates multi-curing and can achieve stronger adhesion capacity.

Moreover, the present invention further claims a display apparatus the display apparatus comprises a first substrate and a second substrate that are disposed oppositely, wherein the first substrate and the second substrate are bonded together through the sealant composition of the present invention. The specific cell process has been described in the prior art and would not be particularly limited in the present invention.

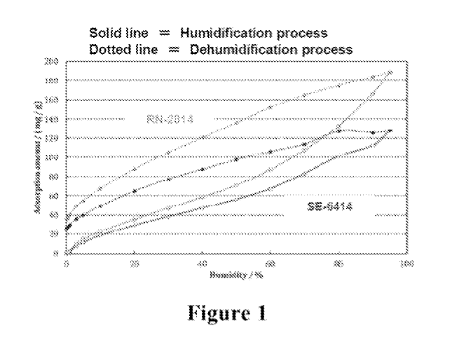

FIG. 1 shows the water adsorption of a conventional alignment layer after rubbing in a humidity environment. The experimental steps specifically comprises: first, conducting water adsorbability test with an increment of humidity environment from 0% to 95% (simulation of water or solvent washing process); then, conducting water adsorbability test with a decrement of humidity from 95% to 0% (simulation of cooling process). In FIG. 1, the solid line represents the humidification process, and the dotted line represents the dehumidification process it can be seen that, water adsorbability increases significantly as the humidity increasing, which is corresponding to the direct contact process between the alignment layer and deionized water (DIW) or other solvent during washing in production; but the adsorbed water is not likely to be removed in the cooling stage of the glass substrate. In mass production, the humidity in the infrared (IR) drying cavity is 80% more or less, which is larger than that of other process. Taking polyimide solution as an example: the amount of adsorbed water before washing is 70 mg/g; the amount of adsorbed water when washing is 190 mg/g; and the amount of adsorbed water after cooling (assuming that the humidity in the IR drying cavity is 80%) is 175 mg/g. so the adsorbed water increases by 105 mg/g before and after the washing process, which is 2.5 times of the original water adsorption amount.

In the technical solution of the present invention, the sealant composition comprises a secondary sealant component that is capable of adsorbing water and then can be moisture-cured; therefore, when carrying out encapsulation by use of the sealant composition of the present invention, the problems of substandard reliability and residual image existed in prior art can be avoided.

A certain level of compatibility between the secondary sealant and the primary sealant in the sealant composition of the present invention can be obtained by selecting suitable components of the secondary and primary sealants, and a desirable matching effect between the primary sealant and the secondary sealant can be achieved by optionally combining suitable coating process, so as to ensure the strength of the cured sealant composition, and further ensure the high adhesion strength and the strong collapse resistance of the integral sealant.

Various coating processes may be applied to the sealant of the present invention, but in order to avoid too large extent of reaction during coating, the amount of secondary sealant (that is, each amount of the dual-curable resin and the bifunctional initiator) should be adjusted appropriately depending on the practical operating environment such as humidity and other factors. If the humidity of the environment or the apparatus is too large, the moisture-curable group may be caused to react rapidly due to the increased moisture content, further leading to increased viscosity and hardening of the integral sealant system, which will affect the subsequent UV-curing and heat-curing reactions. Moreover, if the humidity is too large during coating, the moisture-curable sealant will react in advance and the viscosity of the sealant composition will increase, which will cause the sealant composition difficult to get out of the apparatus, and thereby the disadvantageous phenomenon of sealant breaking occurs. A person skilled in the art can make modifications depending on particular requirements, and this is not particularly limited in the present invention.

Hereafter, the present invention will be described in more details with reference to the examples, but the following examples are exemplified for the purpose of illustration, and the scope of the present invention is not limited to the examples below. Unless otherwise stated, the raw materials used in the examples of the present invention are all commercially available products.

### EXAMPLES

### Example 1

### Preparation of Bifunctional Initiator

The bifunctional initiator in this example was obtained by a modification reaction of hydrogen-containing silicone oil with 2-hydroxy-2-methylpropiophenone, and the specific modification method was as follows:

The hydrogen-containing silicone oil (PMHS) (manufactured by Shanghai Tuhe Industry Co., Ltd.) with a hydrogen content of 0.75 mol/g was used. The hydrogen-containing silicone oil was reacted with 2-hydroxy-2-methylpropiophenone in tetrahydrofuran as solvent with a starting material ratio of n_{Si—H}:n_{—OH}=1:1.1 at 60° C. for 10 h, in the presence of basic catalyst KOH, thus obtaining the bifunctional initiator having a structure as shown below:

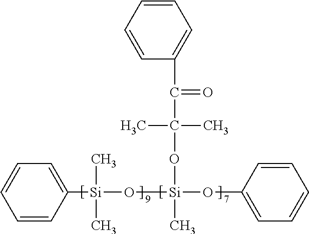 [SMILES: CC(C)(O[Si](C)(Oc1ccccc1)O[Si](C)(C)c1ccccc1)C(=O)c1ccccc1]

### Example 2

### Preparation of Bifunctional Initiator

The hydrogen-containing silicone oil (PMHS) (manufactured by Shanghai Tuhe Industry Co., Ltd.) with a hydrogen content of 0.8 mol/g was used. The hydrogen-containing silicone oil was reacted with 2-hydroxy-2-methylpropiophenone in tetrahydrofuran as solvent with a starting material ratio of n_{Si—H}:n_{—OH}=1:1.15 at 60° C. for 9 h, in the presence of basic catalyst KOH, thus obtaining the bifunctional initiator having a structure as shown below:

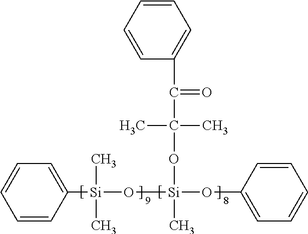 [SMILES: CC(C)(O[Si](C)(Oc1ccccc1)O[Si](C)(C)c1ccccc1)C(=O)c1ccccc1]

### Example 3

### Preparation of Bifunctional Initiator

The hydrogen-containing silicone oil (PMHS) (manufactured by Shanghai Tuhe Industry Co., Ltd.) with a hydrogen content of 0.65 mol/g was used. The hydrogen-containing silicone oil was reacted with 2-hydroxy-2-methylpropiophenone in tetrahydrofuran as solvent with a starting material ratio of n_{Si—H}:n_{—0H}=1:1.05 at 60° C. for 11 h, in the presence of basic catalyst KOH, thus obtaining the bifunctional initiator having a structure as shown below:

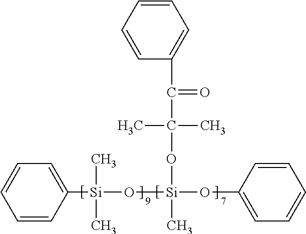 [SMILES: CC(C)(O[Si](C)(Oc1ccccc1)O[Si](C)(C)c1ccccc1)C(=O)c1ccccc1]

### Example 4

### Preparation of Bifunctional Initiator

The hydrogen-containing silicone oil (PMHS) (manufactured by Shanghai Tuhe Industry Co., Ltd.) with a hydrogen content of 0.7 mol/g was used. The hydrogen-containing silicone oil was reacted with 2-hydroxy-2-methylpropiophenone in tetrahydrofuran as solvent with a starting material ratio of n_{Si—H}:n_{—OH}=1:1.1 at 70°×C. for 9 h, in the presence of basic catalyst KOH, thus obtaining the bifunctional initiator having a structure as shown below:

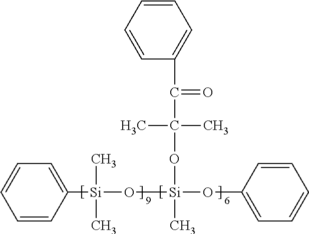 [SMILES: CC(C)(O[Si](C)(Oc1ccccc1)O[Si](C)(C)c1ccccc1)C(=O)c1ccccc1]

### Example 5

### Sealant Composition

The formulation of the sealant composition in this example was as follows: epoxy resin 20 kg, acrylic resin 30 kg, UV photoinitiator 2 kg, heat curing agent 2 kg, inorganic filler 10 kg and organic filler 0.3 kg, dual-curable resin 6 kg, and bifunctional initiator 1.2 kg:

wherein, the epoxy resin was E51 (manufactured by Xi'an Lanxiang Chemicals Co., Ltd.); the acrylic resin was t-butyl acrylate resin; the UV photoinitiator was alkyl acetone UV5184 (manufactured by Jiangyin Mighty Chemicals Co., Ltd.); the heat curing agent was modified aromatic amine heat curing agent R-3200 (manufactured by Guangzhou Rich Chemicals Co., Ltd.); the inorganic filler was silica; the organic filler was cross-linked acrylic monodisperse particles MX-1500H (manufactured by Soken Chemical & amp; Engineering Co., Ltd.); the structure of the dual-curable resin was as follows:

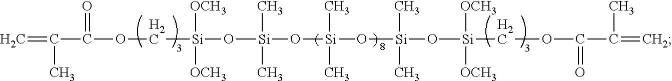

and the bifunctional initiator was the product obtained in Example

### Example 6

### Sealant Composition

The formulation of the sealant composition in this example was as follows: epoxy resin 10 kg, acrylic resin 20 kg, UV photoinitiator 1 kg, heat curing agent 1 kg, inorganic filler 5 kg, dual-curable resin 1 kg, and bifunctional initiator 1 kg:

wherein, the epoxy resin was E44 (manufactured by Xi'an Lanxiang Chemicals Co., Ltd.); the acrylic resin was methyl acrylate resin; the IN photoinitiator was alkyl acetone UV5173 (manufactured by Jiangyin Mighty Chemicals Co., Ltd.); the heat curing agent was modified aromatic amine heat curing agent R-3200 (manufactured by Guangzhou Rich Chemicals Co., Ltd.), the inorganic filler was titania; the structure of the dual-curable resin was as follows:

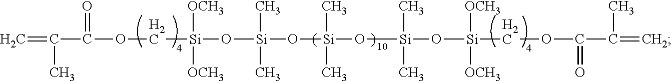

and the bifunctional initiator was the product obtained in Example 2.

### Example 7

### Sealant Composition

The formulation of the sealant composition in this example was as follows: epoxy resin 30 kg, acrylic resin 45 kg, UV photoinitiator 3 kg, heat curing agent 3 kg, inorganic filler 15 kg and organic filler 5 kg, dual-curable resin 10 kg, and bifunctional initiator 1.5 kg:

wherein, the epoxy resin was E51 (manufactured by Xi'an Lanxiang Chemicals Co., Ltd.); the acrylic resin was triphenylmethyl acrylate resin; the UV photoinitiator was alkyl acetone UV5173 (manufactured by Jiangyin Mighty Chemicals Co., Ltd.); the heat curing agent was modified aromatic amine heat curing agent R-3200 (manufactured by Guangzhou Rich Chemicals Co., Ltd.); the inorganic filler was alumina; the organic filler was cross-linked acrylic monodisperse particles MX-1500H (manufactured by Soken Chemical & amp; Engineering Co., Ltd.); the structure of the dual-curable resin was as follows:

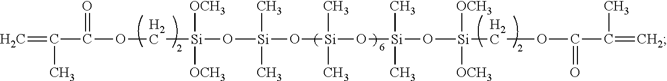

and the bifunctional initiator was the product obtained in Example 3

### Example 8

### Sealant Composition

The formulation of the sealant composition in this example was as follows: epoxy resin 20 kg, acrylic resin 30 kg, UV photoinitiator 1 kg, heat curing agent 1 kg, inorganic filler 10 kg and organic filler 2 kg, dual-curable resin 4 kg, and bifunctional initiator 1.5 kg:

wherein, the epoxy resin was E44 (manufactured by Xi'an Lanxiang Chemicals Co., Ltd.); the acrylic resin was methyl acrylate resin; the UV photoinitiator was alkyl acetone UV5184 (manufactured by Jiangyin Mighty Chemicals Co., Ltd.); the heat curing agent was modified aromatic amine heat curing agent R-3200 (manufactured by Guangzhou Rich Chemicals Co., Ltd.); the inorganic filler was titania, the organic filler was cross-linked acrylic monodisperse particles MX-1500H (manufactured by Soken Chemical & amp; Engineering Co., Ltd.); the structure of the dual-curable resin was as follows:

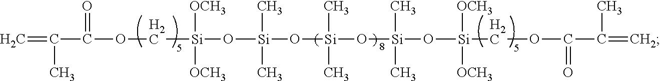

and the bifunctional initiator was the product obtained in Example 4.

### Example 9

### Sealant Composition

The formulation of the sealant composition in this example was as follows: epoxy resin 25 kg, acrylic resin 40 kg, UV photoinitiator 3 kg, heat curing agent 3 kg, inorganic filler 12 kg and organic filler 2 kg, dual-curable resin 8 kg, and bifunctional initiator 1 kg:

wherein, the epoxy resin was E51 (manufactured by Xi'an Lanxiang Chemicals Co., Ltd.); the acrylic resin was t-butyl acrylate resin; the UV photoinitiator was alkyl acetone UV5184 (manufactured by Jiangyin Mighty Chemicals Co., Ltd.); the heat curing agent was modified aromatic amine heat curing agent R-3200 (manufactured by Guangzhou Rich Chemicals Co., Ltd.); the inorganic filler was silica; the organic filler was cross-linked acrylic monodisperse particles MX-1500H (manufactured by Soken Chemical & amp; Engineering Co., Ltd.); the structure of the dual-curable resin was as follows:

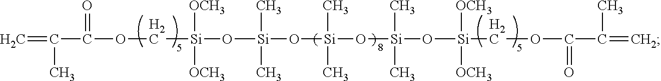

and the bifunctional initiator was the product obtained in Example 1.

Following tests were performed in order to confirm the properties of the sealant composition of the present invention.

### Test Example 1

### Test Object

Test groups 1˜3: the sealant prepared in each Example 5˜7 of the present invention.

Control group 1: compared with Example 5, it differed in the absence of secondary sealant (i.e., the dual-curable resin and the bifunctional initiator);

Control group 2: the conventional sealant disclosed in prior art under trade name UR2920 (manufactured by SEKISUI CHEMICAL CO., Ltd.).

Test Method:

a cell process of a first substrate (TFT substrate with 0.5 mm thickness) and a second substrate (CF substrate with 0.5 mm thickness) disposed oppositely was performed by use of a polyimide solution SE-6514 (manufactured by Nissan Chemical Industries, Ltd.) and the sealant systems in the test and control groups with a sealant width of 0.7 mm, wherein the cell gap was 3.5 μm. The UV-curing was conducted under a irradiation intension of 7000 mJ/cm² by a UV light with 365 nm wavelength for 2 min, and the heat-curing was conducted at 120° C. for 60 min. Said substrates were all purchased from BOE Technology Group Co., Ltd. After the sealant was cured completely, 4.5-inch peel off data of the obtained cell was determined by INSTRON-5944 (made by INSTRON Corporation), wherein it was evaluated OK if the average peel-off force of the left pad and the right pad was not less than 1.25 kgf, otherwise it was evaluated NG. Specific test method was described as below: an external force, which was perpendicular to the surface of the first substrate, was applied on the left portion of the first substrate beyond the second substrate, and the minimum external force that can separate the first substrate from the second substrate was measured, which was defined as the peel-off force for the left pad. Likewise, the peel-off force for the right pad was measured, and thus the average value calculated from the above-measured peel-off forces was the average peel-off force. Furthermore, the collapse level of the liquid crystal n (n=4×L′/L) was determined, wherein L′ was the distance in the sealant to which the liquid crystal had reached, and L was the sealant width. Test result is shown in Table 1.

TABLE 1

| | Test | Test | Test | Control | Control |
|---|---|---|---|---|---|
| | group | group | group | group | group |
| Sample | 1 | 2 | 3 | 1 | 2 |
| Left pad (kgf) | 1.49 | 1.54 | 1.58 | 1.12 | 1.16 |
| Right pad (kgf) | 1.56 | 1.53 | 1.49 | 1.21 | 1.19 |
| Bonding | OK | OK | OK | NG | NG |
| strength | | | | | |
| Collapse Level | 0 | 0 | 0 | 1 | 2 |

The above test examples fully indicate that the sealant strength can be significantly improved and the adhesion strength and the collapse-resistance level of the sealant can be enhanced as well by using the sealant composition of the present invention comprising the secondary sealant.

It should be understand that the embodiments described in above examples can be further combined or replaced, and the examples are merely described as preferred embodiments of the invention, which shall not limit the spirit and scope of the invention. Various changes and modifications to the present technical solutions made without departing from the spirit of invention by a person skilled in the art should all be covered in the protection scope of the present invention.

1. A sealant composition, characterized in that the composition comprises a heat-curable and/or UV-curable primary sealant and a both UV-curable and moisture-curable secondary sealant.

2. The sealant composition according to claim 1, characterized in that the secondary sealant comprises a dual-curable resin which is a silicone resin including an UV-curable group 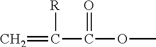
and a Si-containing moisture-curable group, wherein R in the UV-curable group is H or C1˜C20 alkyl, and at least one —OCH₃ group is linked to the silicone atom in the Si-containing moisture-curable group.

3. The sealant composition according to claim 2, characterized in that the dual-curable resin has a general structure represented by formula I: 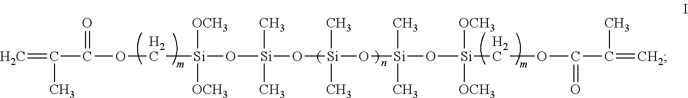
wherein, m≧2, n≧0.

4. The sealant composition according to claim 3, characterized in that said m is 2˜30, n is 0˜20.

5. The sealant composition according to claim 3, characterized in that said m is 2˜6, n is 3˜15.

6. The sealant composition according to claim 5, characterized in that the dual-curable resin is the compound represented by formula II:

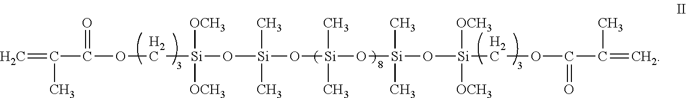

7. The sealant composition according to claim 2, characterized in that the secondary sealant further comprises a bifunctional initiator capable of initiating UV-curing and moisture-curing of the secondary sealant.

8. The sealant composition according to claim 7, characterized in that the bifunctional initiator is obtained from a modification reaction between hydrogen-containing silicone oil and 2-hydroxy-2-methylpropiophenone.

9. The sealant composition according to claim 1, characterized in that the sealant composition comprises, in terms of weight parts, 10˜30 parts of epoxy resin, 20˜45 parts of acrylic resin, 1˜3 parts of UV photoinitiator, 1˜3 parts of heat curing agent, 5˜15 parts of inorganic filler, 0˜5 parts of organic filer, 1˜10 parts of dual-curable resin, and 1˜1.5 parts of bifunctional initiator.

10. The sealant composition according to claim 9, characterized in that the epoxy resin is selected from E51 or E44; the acrylic resin is selected from acrylate resin; the UV photoinitiator is alkyl acetone photoinitiator; the heat curing agent is selected from amine heat curing agent; the inorganic filler is selected from silica, mania or alumina; and the organic filler is selected from cross-linked acrylic monodisperse particles.

11. The sealant composition according to claim 10, characterized in that the acrylic resin is one or more selected from t-butyl acrylate resin, methyl acrylate resin or triphenylmethyl acrylate resin, the alkyl acetone photoinitiator is UV5184 and/or UV5173, the organic filler is MX-1500H, and the amine heat curing agent is a modified aromatic amine heat curing agent.

12. The sealant composition according to claim 9, characterized in that the sealant composition comprises the following raw materials (by weight parts): epoxy resin E51 or E44 20˜25 parts, t-butyl acrylate resin 30˜40 parts, UV photoinitiator UV5184 1˜3 parts, modified aromatic amine heat curing agent R-3200 1˜3 parts, inorganic filler silica 10˜12 parts, organic filler MX-1500H 2˜5 parts, dual-curable resin 4˜8 parts, and bifunctional initiator 1˜1.5 parts; wherein, the dual-curable resin has a structure of: 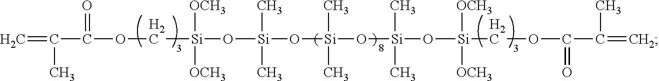
and the bifunctional initiator has a structure of:

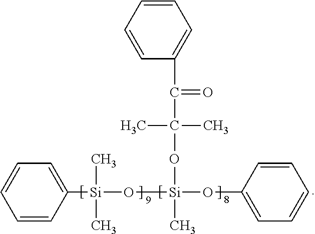 [SMILES: CC(C)(O[Si](C)(Oc1ccccc1)O[Si](C)(C)c1ccccc1)C(=O)c1ccccc1]

13. A method for preparing the sealant composition of claim 1, characterized in that uniformly mixing the primary sealant with the secondary sealant to obtain the sealant composition.

14. A display apparatus, characterized in that the display apparatus comprises a first substrate and a second substrate that are disposed oppositely, and the first substrate and the second substrate are bonded by the sealant composition which comprising a heat-curable and/or UV-curable primary sealant and a both UV-curable and moisture-curable secondary sealant.
